(19) United States
(12) Patent Application Publication
(10) Pub. No.: US 2026/0323678 A1
(43) Pub. Date: Oct. 15, 2026

(54) COMMUNICATION METHOD AND APPARATUS, COMMUNICATION DEVICE, COMMUNICATION SYSTEM, AND STORAGE MEDIUM

(71) Applicant: Beijing Xiaomi Mobile Software Co., Ltd., Beijing (CN)

(72) Inventors: Min LIU, Beijing (CN); Zhengxuan LIU, Beijing (CN)

(73) Assignee: Beijing Xiaomi Mobile Software Co., Ltd., Beijing (CN)

(21) Appl. No.: 19/483,313

(22) PCT Filed: May 12, 2023
(86) PCT No.: PCT/CN2023/094079

§ 371 Date: Nov. 11, 2025

(51) Int. Cl. H04W 72/542; H04L 5/00

(52) U.S. Cl. CPC H04W 72/542; H04L 5/0057

(57) ABSTRACT

Embodiments of the present disclosure provide a communication method and apparatus, and a storage medium. The communication method is executed by a terminal. The method comprises: sending first information, wherein the first information indicates that a first condition is satisfied, the first condition is determined according to at least one of the following: performance of a first processing method and performance of at least one second processing method, the first processing method is used for channel state information (CSI) reporting, and the second processing method is used for performance monitoring. The timing of sending first information is more reasonable.

### CROSS-REFERENCE TO RELATED APPLICATIONS

The present application is a U.S. National Stage of International Application No. PCT/CN2023/094079, filed on May 12, 2023, the disclosure of which is incorporated herein by reference in its entirety for all purposes.

### TECHNICAL FIELD

The present disclosure relates to the field of communication technologies, and in particular to a communication method and apparatus, a communication device, a communication system, and a storage medium.

### BACKGROUND

A terminal sends channel state information (CSI) to a network device so that the network device can take the channel quality into consideration when performing downlink scheduling.

### SUMMARY

Embodiments of the present disclosure provide a communication method and apparatus, a communication device, a communication system, and a storage medium.

According to a first aspect of an embodiment of the present disclosure, a communication method is provided, which is performed by a terminal. The method includes:
sending first information, where the first information indicates that a first condition is met, and the first condition is determined based on at least one of the following:
performance of a first processing method; or
performance of at least one second processing method;
where the first processing method is used for channel state information (CSI) reporting, and the second processing method is used for performance monitoring.

According to a second aspect of an embodiment of the present disclosure, a communication method is provided, which is performed by a network device. The method includes:
receiving first information, where the first information indicates that a first condition is met, and the first condition is determined based on at least one of the following:
performance of a first processing method; or
performance of at least one second processing method;
where the first processing method is used for channel state information (CSI) reporting, and the second processing method is used for performance monitoring.

According to a third aspect of an embodiment of the present disclosure, a communication method is provided, which is applied to a communication system. The method includes:
send first information by a terminal;
receiving the first information by a network;
where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

According to a fourth aspect of an embodiment of the present disclosure, a first communication apparatus is provided, the apparatus including:
a transceiving module, configured to send first information, where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

According to a fifth aspect of an embodiment of the present disclosure, a second communication apparatus is provided, the apparatus including:
a transceiving module, configured to receive first information, where the first information indicates that a first condition is met, and the first condition is determined based on at least one of the following:
performance of a first processing method; or
performance of at least one second processing method;
where the first processing method is used for channel state information (CSI) reporting, and the second processing method is used for performance monitoring.

According to a sixth aspect of an embodiment of the present disclosure, a communication device is proposed, including one or more processors; where the processors are configured to call instructions to cause the communication device to perform the method described in the first aspect or the second aspect.

According to a seventh aspect of an embodiment of the present disclosure, a communication system is proposed, including a terminal and a network device, where the terminal is configured to implement the method described in the first aspect, and the access network device is configured to implement the method described in the second aspect.

According to an eighth aspect of an embodiment of the present disclosure, a storage medium is proposed, the storage medium stores instructions, where when the instructions are running on a communication device, the communication device is caused to perform the method described in the first aspect or the second aspect.

It is to be understood that the foregoing general description and the following detailed description are illustrative and explanatory only and are not restrictive of the disclosure.

### BRIEF DESCRIPTION OF THE DRAWINGS

In order to more clearly illustrate the technical solutions in the embodiments of the present disclosure, the drawings required for describing the embodiments are introduced below. The following drawings are merely some embodiments of the present disclosure and do not impose specific limitations on the protection scope of the present disclosure.

FIG. 1 is a schematic diagram showing an architecture of a communication system according to an embodiment of the present disclosure.

FIG. 2 is an interactive schematic diagram showing a communication method according to an embodiment of the present disclosure.

FIGS. 3A-3E are flow charts showing a communication method according to an embodiment of the present disclosure.

FIGS. 4A-4D are flow charts showing a communication method according to an embodiment of the present disclosure.

FIG. 5 is an interactive schematic diagram showing a communication method according to an embodiment of the present disclosure.

FIG. 6 is a flow chart showing a communication method according to an embodiment of the present disclosure.

FIGS. 7A-7B are schematic diagrams showing a communication apparatus according to an embodiment of the present disclosure.

FIGS. 8A-8B are schematic diagrams showing a communication apparatus according to an embodiment of the present disclosure.

### DETAILED DESCRIPTION

The embodiments of the present disclosure provide a communication method and apparatus, a communication device, a communication system, and a storage medium.

According to a first aspect of an embodiment of the present disclosure, a communication method is provided, which is performed by a terminal. The method includes:
sending first information, where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

In the above embodiments, by referring to the performance of different processing methods, the opportunity for sending the first information is made more reasonable and accurate.

In conjunction with some embodiments of the first aspect, in some embodiments, the first condition includes at least one of the following:
the performance of the first processing method is worse than or equal to a first requirement;
the performance of any one of the at least one second processing method is better than or equal to a second requirement;
the performance of part of the at least one second processing method is better than or equal to the second requirement;
the performance of the first processing method is worse than or equal to the performance of any one of the second processing methods;
the performance of the first processing method is worse than or equal to the performance of part of the second processing methods; or
the first processing method processes the CSI based on a first model, and a difference in distribution between first data and second data of the first model is greater than a third requirement.

In the above embodiments, the first condition is set in different dimensions, which can improve the triggering effectiveness of the first condition.

In conjunction with some embodiments of the first aspect, in some embodiments, the first processing method processes the CSI based on a first model;
the second CSI processing method processes the CSI based on a second model, or the second CSI processing method processes the CSI based on a codebook;
where the first model and the second model are different from each other.

In the above embodiments, the difference between the first processing method and the second processing method can enable the first condition to refer to different processing methods, thereby improving the triggering effectiveness of the first condition.

In conjunction with some embodiments of the first aspect, in some embodiments, the method further includes:
receiving second information, where the second information includes information for configuring a CSI downlink reference signal, and the information for configuring the CSI downlink reference signal is used to determine at least one of the following:
performance of the first processing method; or
performance of at least one of the second processing methods.

In the above embodiments, the performance of the processing methods is determined according to the information for configuring the CSI downlink reference signal, making the first condition more reasonable.

In conjunction with some embodiments of the first aspect, in some embodiments, the method further includes:
sending third information;
where the third information indicates the performance of the first processing method, or the third information indicates the performance of the first processing method and the performance of at least one of the second processing methods.

In the above embodiments, the performance is made to be used where it is needed.

In combination with some embodiments of the first aspect, in some embodiments, the method further includes: receiving fourth information, where the fourth information includes information for indicating a threshold.

In the above embodiments, the first condition can be flexibly adjusted according to usage requirements.

In conjunction with some embodiments of the first aspect, in some embodiments, the fourth information includes at least one of the following:
at least one first threshold; or
at least one second threshold;
where the at least one first threshold is used for the first requirement, and the at least one second threshold is used for the second requirement.

In the above embodiments, the first requirement and the second requirement in the first condition can be flexibly adjusted according to usage requirements.

In combination with some embodiments of the first aspect, in some embodiments, the performance of the first processing method includes the performance of the first processing method in at least one layer; the performance of the second processing method includes the performance of the second processing method in at least one layer; and the layer is a layer in multi-layer transmission.

In the above embodiments, the granularity of the performance is increased to make the performance more accurate.

In combination with some embodiments of the first aspect, in some embodiments, the first threshold corresponds to the at least one layer, and the second threshold corresponds to the at least one layer.

In the above embodiments, the granularity of the performance is increased, making the performance more accurate.

In conjunction with some embodiments of the first aspect, in some embodiments, the performance includes at least one of the following:
a square of generalized cosine similarity (SGCS); a normalized mean square error (NMSE); a generalized cosine similarity (GCS); or an assumed block error rate.

In the above embodiments, the diversity and compatibility of the performance are improved.

In a second aspect, an embodiment of the present disclosure provides a communication method, performed by a network device, the method including:
receiving first information, where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

In conjunction with some embodiments of the second aspect, in some embodiments, the first condition includes at least one of the following:
the performance of the first processing method is worse than or equal to a first requirement;
the performance of any one of the at least one second processing method is better than or equal to a second requirement;
the performance of part of the at least one second processing method is better than or equal to the second requirement;
the performance of the first processing method is worse than or equal to the performance of any one of the second processing methods;
the performance of the first processing method is worse than or equal to the performance of part of the second processing methods; or
the first processing method processes the CSI based on a first model, and a difference in distribution between first data and second data of the first model is greater than a third requirement.

In conjunction with some embodiments of the second aspect, in some embodiments, the first processing method processes the CSI based on a first model;
the second CSI processing method processes the CSI based on a second model, or the second CSI processing method processes the CSI based on a codebook;
where the first model and the second model are different.

In conjunction with some embodiments of the second aspect, in some embodiments, the method further includes:
receiving second information;
where the second information indicates the performance of the first processing method, or the second information indicates the performance of the first processing method and the performance of at least one of the second processing methods.

In conjunction with some embodiments of the second aspect, in some embodiments, the method further includes:
sending third information, where the third information includes information for configuring a CSI downlink reference signal, and the information for configuring the CSI downlink reference signal is used to determine at least one of the following:
the performance of the first processing method;
the performance of at least one of the second processing methods.

In conjunction with some embodiments of the second aspect, in some embodiments, the method further includes:
sending fourth information, where the fourth information includes information indicating a threshold.

In conjunction with some embodiments of the second aspect, in some embodiments, the fourth information includes at least one of the following:
at least one first threshold; or
at least one second threshold;
where the at least one first threshold is used for the first requirement, and the at least one second threshold is used for the second requirement.

In conjunction with some embodiments of the second aspect, in some embodiments, the performance of the first processing method includes performance of the first processing method in at least one layer; and
the performance of the second processing method includes the performance of the second processing method in at least one layer;
where the layer is a layer in multi-layer transmission.

In conjunction with some embodiments of the second aspect, in some embodiments, the first threshold corresponds to the at least one layer; and
the second threshold corresponds to the at least one layer.

In conjunction with some embodiments of the second aspect, in some embodiments, the performance includes at least one of the following:
a square of generalized cosine similarity (SGCS);
a normalized mean square error (NMSE);
a generalized cosine similarity (GCS); or
an assumed block error rate.

In a third aspect, an embodiment of the present disclosure provides a communication method used for a communication system, the method including:
a terminal sends first information; and
a network device receives the first information;
where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

In a fourth aspect, an embodiment of the present disclosure provides a first communication apparatus, which can include a transceiving module, where the transceiving module can be configured to support transmission and reception by the communication apparatus. When performing the steps described in the first aspect, the transceiving module is configured to send first information, where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

In a fifth aspect, an embodiment of the present disclosure provides a second communication apparatus, which can include a transceiving module, where the transceiving module can be configured to support transmission and reception by the communication apparatus. When performing the steps described in the second aspect, the transceiving module is configured to receive first information, where the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

In a sixth aspect, an embodiment of the present disclosure provides a communication device, including a processor and a memory, where:
where the processor is configured to call instructions to cause the communication device to perform the communication method described in the optional implementations of the first aspect, or the communication method described in the optional implementations of the second aspect.

In a seventh aspect, an embodiment of the present disclosure provides a communication system, including a terminal and a network device, where the terminal is configured to implement the communication method described in the optional implementations of the first aspect, and the network device is configured to implement the communication method described in the optional implementations of the second aspect.

In an eighth aspect, an embodiment of the present disclosure provides a storage medium having stored instructions, and the instructions, when running on a communication device, cause the communication device to perform the method described in the optional implementations of the first aspect or the second aspect.

In a ninth aspect, an embodiment of the present disclosure provides a program product, and the program product, when being executed by a communication device, cause the communication device to perform the method described in the optional implementations of the first aspect or the second aspect.

In a tenth aspect, an embodiment of the present disclosure provides a computer program which, when running on a computer, causes the computer to perform the method described in the optional implementations of the first aspect or the second aspect.

It can be understood that the first communication apparatus, the second communication apparatus, the communication device, the communication system, the storage medium, the program product, and the computer program are all used to perform the methods provided by the embodiments of the present disclosure. Therefore, for the beneficial effects that can be achieved thereby, reference can be made to the beneficial effects in the corresponding methods, which will not be repeated here.

The embodiments of the present disclosure provide a communication method and apparatus, and a readable storage medium. In some embodiments, the terms communication method, processing method, and information processing method are interchangeable; the terms communication apparatus, processing apparatus, and information processing apparatus are interchangeable; and the terms communication system, processing system, and information processing system are interchangeable.

The embodiments of the present disclosure are not exhaustive and are merely illustrative of some embodiments, and are not intended to be specific limitations on the protection scope of the present disclosure. Each step in a certain embodiment can be implemented as an independent embodiment and the steps can be arbitrarily combined if there is no contradiction. For example, a solution with some steps in a certain embodiment removed can also be implemented as an independent embodiment, and the order of the steps in a certain embodiment can be arbitrarily exchanged. In addition, the optional implementations in a certain embodiment can be arbitrarily combined, and furthermore, the embodiments can be arbitrarily combined. For example, some or all steps of different embodiments can be arbitrarily combined, and a certain embodiment can be arbitrarily combined with the optional implementations of other embodiments.

In the embodiments of the present disclosure, if there is no special indication or logical conflict, the terms and/or descriptions among the embodiments are consistent and can be referenced by each other, and the technical features in different embodiments can be combined to form a new embodiment based on their inherent logical relationships.

The terms used in the embodiments of the present disclosure are only for the purpose of describing specific embodiments and are not intended to limit the present disclosure.

In some embodiments, data, information, etc. can be obtained in compliance with the local national laws and regulations.

In some embodiments, data, information, etc. can be obtained with the user's consent.

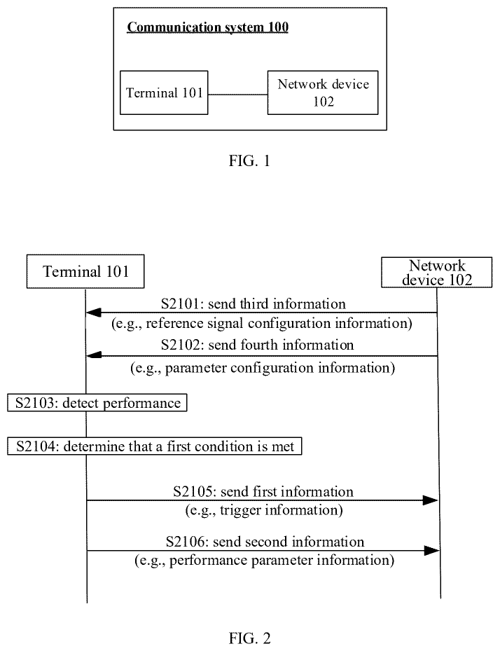

FIG. 1 is a schematic diagram showing an architecture of a communication system according to an embodiment of the present disclosure.

As shown in FIG. 1, a communication system 100 includes a terminal 101 and a network device 102.

In some embodiments, the terminal 101 includes, for example, at least one of a mobile phone, a wearable device, an Internet of Things device, a car with communication capabilities, a smart car, a tablet computer (pad), a computer with wireless transceiving capabilities, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, and a wireless terminal device in a smart home, but is not limited thereto.

In some embodiments, the network device 102 may include at least one of an access network device and a core network device.

In some embodiments, the access network device is, for example, a node or device that connects a terminal to a wireless network. The access network device may include at least one of an evolved Node B (eNB), a next generation evolved Node B (ng-eNB), a next generation Node B (gNB), a Node B (NB), a home node B (HNB), a home evolved node B (HeNB), a wireless backhaul device, a radio network controller (RNC), a base station controller (BSC), a base transceiver station (BTS), a baseband unit (BBU), a mobile switching center, a base station in a 6G communication system, an open base station (OpenRAN), a cloud base station (CloudRAN), a base station in other communication systems, and an access node in a wireless fidelity (WiFi) system, but is not limited thereto.

In some embodiments, the technical solution of the present disclosure can be applied to the OpenRAN architecture. In this case, the interfaces between access network devices or within an access network device involved in the embodiments of the present disclosure can be changed into internal interfaces of OpenRAN, and the processes and information interactions between these internal interfaces can be implemented through software or programs.

In some embodiments, the access network device may be composed of a centralized unit (CU) and a distributed unit (DU), where the CU may also be referred to as a control unit. Employing the CU-DU structure can separate the protocol layers of the access network device, with functions of some protocol layers being centrally controlled by the CU and some or all functions of the remaining protocol layers being distributed in the DU, and the DU is centrally controlled by the CU, but it is not limited thereto.

In some embodiments, a core network device may be a single device including one or more network elements, or may be multiple devices or device clusters, each including all or part of one or more network elements. The network element may be virtual or physical. For example, the core network includes at least one of an Evolved Packet Core (EPC), a 5G Core Network (5GCN), or a Next Generation Core (NGC).

It can be understood that the communication system described in the embodiments of the present disclosure is for the purpose of more clearly illustrating the technical solution of the embodiments of the present disclosure, and does not constitute a limitation on the technical solution provided by the embodiments of the present disclosure. Those of ordinary skill in the art can understand that with the evolution of the system architecture and the emergence of new business scenarios, the technical solution provided by the embodiments of the present disclosure is also applicable to similar technical problems.

The following embodiments of the present disclosure may be applied to the communication system 100 shown in FIG. 1, or a portion thereof, but are not limited thereto. The entities shown in FIG. 1 are illustrative only. The communication system may include all or part of the entities shown in FIG. 1, or may include other entities beyond FIG. 1, the number and configuration of the entities may be arbitrary, and the connections between the entities are illustrative only. The entities may be not connected or may be connected, and the connections may be in any manner, which may be direct or indirect, wired or wireless.

The embodiments of the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G New Radio (NR), Future Radio Access (FRA), New Radio Access Technology (RAT), New Radio (NR), New Radio Access (NX), Future Generation Radio Access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), Public Land Mobile Network (PLMN) networks, Device-to-Device (D2D) systems, Machine-to-Machine (M2M) systems, Internet of Things (IoT) systems, Vehicle-to-Everything (V2X), systems utilizing other communication methods, and next-generation systems extended based thereon. Furthermore, a combination of multiple systems (for example, a combination of LTE or LTE-A with 5G) may also be used.

In the embodiments of the present disclosure, a terminal may utilize a CSI compression model including an encoder and a decoder, the encoder is deployed in the terminal and the decoder is deployed in a network device. The terminal measures a downlink reference signal to obtain complete channel information, preprocesses the complete channel information, encodes the preprocessed information using the encoder, and reports the encoded information to the network device. After receiving the encoded information, the network device decodes it using the decoder to obtain complete channel information.

In the embodiments of the present disclosure, the terminal 101 sends the quantized CSI to the network device 102.

In an example, an encoder of a CSI compression model is deployed in the terminal 101. The encoder includes a quantization module. The encoder outputs quantized CSI, and the terminal 101 sends the quantized CSI to the network device 102.

In another example, an encoder of a CSI compression model is deployed in the terminal 101, and the encoder does not include a quantization module. The terminal 101 quantizes the CSI output by the encoder and sends it to the network device 102.

In the embodiments of the present disclosure, the performance of the CSI compression model may be limited by the training dataset and may not be able to effectively compress the channel data in the current scenario. This may result in the network device 102 being unable to obtain accurate CSI, further causing the network device 102 to use inappropriate transmission data, thereby degrading system performance. In an example, the transmission data includes at least one of the following: a modulation and coding scheme (MCS) or a precoding matrix indicator (PMI). Therefore, it is necessary to monitor the performance of the CSI compression model to ensure that when the CSI compression model performance does not meet the requirements, it is promptly detected and corresponding processing is performed. The corresponding processing may be using another CSI compression model or using a traditional codebook-based CSI reporting method.

In the embodiments of the present disclosure, the performance of the CSI compression model is monitored by the terminal 101 or the network device 102, which are respectively described below in two manners.

In a first manner, the performance of the CSI compression model is monitored by the terminal 101.

Optionally, in addition to the encoder, a proxy decoder is deployed in the terminal 101. The proxy decoder calculates performance parameters for evaluating the CSI compression model. The calculated performance parameters are reported to the network device 102. After receiving the performance parameters, the network device 102 performs corresponding processing, and the corresponding processing is using another CSI compression model or using a traditional codebook-based CSI reporting method.

In an example, the performance parameter for evaluating the CSI compression model calculated based on the proxy decoder is a SGCS, and the SGCS can be considered to have association with a SGCS measured by the decoder deployed in the network device 102.

In a second manner, the performance of the CSI compression model is monitored by the network device 102.

Optionally, the terminal 101 measures the downlink reference signal to obtain a ground-truth CSI, and reports the ground-truth CSI to the network device 102. A decoder in the network device 102 outputs a CSI, and the network device 102 determines the similarity between this CSI and the ground-truth CSI, and evaluates the performance of the CSI compression model based on the similarity.

Optionally, the CSI output by the decoder in the network device 102 may be channel matrix information or channel precoding information. When the CSI is the channel precoding information, the precoding information is obtained by preprocessing by the terminal 101, where the preprocessing is preprocessing performed on the measured channel matrix information.

Optionally, the preprocessing is one of the following:
performing singular value decomposition (SVD) on the channel matrix to obtain eigenvector information with dimensions equal to the number of transmitting antennas of the network device 102; or performing further processing on the eigenvector obtained from the SVD decomposition, where the further information is to map to an angle-delay domain through DFT transformation.

Optionally, the ground-truth CSI may also be used as input information for the encoder in the terminal 101.

FIG. 2 is an interactive schematic diagram of a communication method according to an embodiment of the present disclosure. As shown in FIG. 2, the communication method involved in the embodiment of the present disclosure is used in a communication system 100, and the method includes the following steps.

Step S2101, a network device 102 sends third information.

In some embodiments, the names of information, etc. are not limited to the names described in the embodiments, and terms such as “information”, “message”, “signal”, “signaling”, “report”, “configuration”, “indication”, “instruction”, “command”, “channel”, “parameter”, “domain”, “field”, “symbol”, “codebook”, “codeword”, “codepoint”, “bit”, “data”, “program”, and “chip” can be used interchangeably.

In some embodiments, a terminal 101 receives the third information.

In some embodiments, the third information is used to configure downlink resources.

In some embodiments, the third information is downlink resource configuration information.

In some embodiments, the third information is used to configure a reference signal.

In some embodiments, the third information is reference signal configuration information.

In some embodiments, the third information is used to configure a CSI downlink reference signal.

In some embodiments, the third information is CSI downlink reference signal configuration information.

In some embodiments, the third information includes information for configuring a CSI downlink reference signal, and the information for configuring the CSI downlink reference signal is used to determine at least one of the following:
performance of a first processing method; or
performance of at least one second processing method.

In some embodiments, the names of configurations, etc. are not limited to the names described in the embodiments, and terms such as “configuration” and “setting” can be used interchangeably.

In some embodiments, the performance of the first processing method includes: performance of the first processing method in at least one layer.

In some embodiments, the performance of the second processing method includes: performance of the second processing method in at least one layer.

Optionally, the layer is a layer in multi-layer transmission.

Optionally, a rank in the multi-layer transmission is greater than 1.

In some embodiments, the performance includes at least one of the following:
a SGCS; a NMSE; a GCS; or an assumed block error rate

In some embodiments, the network device 102 sends Radio Resource Control (RRC) information, and the RRC information includes the third information.

In some embodiments, the terminal 101 receives the RRC information.

Step S2102, the network device 102 sends fourth information.

In some embodiments, the fourth information is used for configuring a parameter.

In some embodiments, the fourth information is parameter configuration information.

In some embodiments, the fourth information is used to configure a parameter for detecting performance.

In some embodiments, the network device 102 sends the fourth information.

In some embodiments, the fourth information includes at least one of the following:
information for indicating a time duration; or
information for indicating the number of detections.

Optionally, the fourth information includes information for indicating a first time duration, where the first time duration corresponds to a first requirement.

Optionally, the fourth information includes information indicating a first value, where the first value corresponds to the first requirement. The first value is an integer greater than 1.

Optionally, the fourth information includes: information indicating a second time duration and a second value, where the second time duration and the second value correspond to the first requirement, and the second value is an integer greater than 1.

Optionally, the fourth information includes: information for indicating a third time duration, where the third time duration corresponds to a second requirement.

Optionally, the fourth information includes: information for indicating a third value, where the third value corresponds to the second requirement and the third value is an integer greater than 1.

Optionally, the fourth information includes: information for indicating a fourth time duration and a fourth value, the fourth time duration and the fourth value correspond to the second requirement, and the fourth value is an integer greater than 1.

Optionally, the fourth information includes: information for indicating a fifth time duration, where the fifth time duration corresponds to a third requirement.

Optionally, the fourth information includes: information for indicating a fifth value, the fifth value corresponds to the third requirement, and the fifth value is an integer greater than 1.

Optionally, the fourth information includes: information for indicating a sixth time duration and a sixth value, the sixth time duration and the sixth value correspond to the third requirement, and the sixth value is an integer greater than 1.

In some embodiments, the fourth information includes information for indicating a threshold.

In some embodiments, the fourth information includes at least one of the following:
at least one first threshold; or
at least one second threshold.

In some embodiments, the first threshold corresponds to at least one layer; the second threshold corresponds to at least one layer, and the layer is a layer in the multi-layer transmission.

In some embodiments, the network device 102 sends RRC information, and the RRC information includes the fourth information.

In some embodiments, the terminal 101 receives RRC information.

Step S2103, the terminal 101 detects performance.

In some embodiments, the terms “detect”, “monitor”, “listen”, “test”, etc. may be interchangeable.

In some embodiments, the terminal 101 detects the performance of the first processing method once or multiple times.

In some embodiments, the terminal 101 detects the performance of the second processing method once or multiple times.

In some embodiments, the terminal 101 detects the performance of the first processing method and the performance of the second processing method once or multiple times.

In some embodiments, in a case where the fourth information in step S2102 includes the information for indicating the first time duration, the terminal 101 detects the performance of the first processing method once or multiple times within the first time duration.

In some embodiments, in a case where the fourth information in step S2102 includes the information for indicating the first value, the terminal 101 detects the performance of the first processing method once or multiple times, and the number of detections is the first value.

Optionally, the first value is an integer greater than or equal to 1.

In some embodiments, in a case where the fourth information in step S2102 includes the information for indicating the second time duration and the second value, the terminal 101 detects the performance of the first processing method once or multiple times, and stops detecting the performance parameters of the first model when the detection time duration reaches the second time duration or the number of detections reaches the second value.

In some embodiments, in a case where the fourth information in step S2102 includes the information for indicating the third time duration, the terminal 101 detects the performance of the second processing method once or multiple times within the third time duration.

In some embodiments, in a case where the fourth information in step S2102 includes the information for indicating the third value, the terminal 101 detects the performance of the second processing method once or multiple times, and the number of detections is the third value.

Optionally, the third value is an integer greater than or equal to 1.

In some embodiments, in a case where the fourth information in step S2102 includes the information for indicating the fourth time duration and the fourth value, the terminal 101 detects the performance of the second processing method once or multiple times, and stops detecting the performance of the second processing method when the detection time duration reaches the fourth time duration or the number of detections reaches the fourth value.

In some embodiments, in a case where the fourth information in step S2102 includes the information for indicating the fifth time duration, the terminal 101 detects the performance of the first processing method and the second processing method once or multiple times within the fifth time duration.

In some embodiments, in a case where the fourth information in step S2102 includes the information for indicating the fifth value, the terminal 101 detects the performance of the first processing method and the second processing method once or multiple times, and the number of detections is the fifth value.

Optionally, the fifth value is an integer greater than or equal to 1.

In some embodiments, in a case where the fourth information in step S2102 includes the information for indicating the sixth time duration and the sixth value, the terminal 101 detects the performance of the first processing method and the second processing method once or multiple times, and stops detecting the performance of the first processing method and the second processing method when the detection time duration reaches the sixth time duration or the number of detections reaches the sixth value.

Step S2104, the terminal determines that a first condition is met.

In some embodiments, the first condition is used to supervise the performance of the CSI processing method.

In some embodiments, the first condition is determined according to at least one of the following:
performance of a first processing method; or
performance of at least one second processing method.

In some embodiments, the first processing method is used for channel state information (CSI) reporting.

Optionally, the second processing method is used for performance monitoring.

In some embodiments, the first processing method is a method for CSI processing that is currently being used.

Optionally, the second processing method is a backup method for CSI processing.

In some embodiments, the first processing method is a method for CSI processing that is serving.

Optionally, the second processing method is a method for CSI processing that is not serving.

In some embodiments, the output result of the first processing method is used for CSI reporting.

Optionally, the output result of the second processing method is not used for CSI reporting.

In some embodiments, the output result of the first processing method is used for CSI reporting.

Optionally, the output result of the second processing method is used for performance monitoring.

In some embodiments, the output result of the first processing method is used for CSI reporting.

Optionally, the output result of the second processing method is not used for CSI reporting, and is used for performance monitoring.

In some embodiments, the first condition includes at least one of the following:
the performance of the first processing method is worse than or equal to a first requirement;
the performance of any one of the at least one second processing method is better than or equal to a second requirement;
the performance of part of the at least one second processing method is better than or equal to the second requirement;
the performance of the first processing method is worse than or equal to the performance of any of the second processing methods;
the performance of the first processing method is worse than or equal to the performance of part of the second processing methods; or
the first processing method processes the CSI based on a first model, and a difference in distribution between first data and second data of the first model is greater than a third requirement.

Optionally, the performance of the first processing method and the performance of the at least one second processing method meet the third requirement, including:
the performance of the first processing method is worse than or equal to the performance of any of the second processing methods; or
the performance of the first processing method is worse than or equal to the performance of part of the second processing method.

In some embodiments, terms such as “any”, “a”, and “first” can be used interchangeably.

In some embodiments, the first processing method processes the CSI based on a first model.

In some embodiments, the second CSI processing method processes the CSI based on a second model, or the second CSI processing method processes the CSI based on a codebook; and the first model and the second model are different.

Optionally, the codebook may be a Type I codebook, a Type II codebook, or an enhanced eType II codebook.

In some embodiments, the terms “codebook”, “codeword”, “symbol”, “precoding matrix”, etc. may be used interchangeably. For example, a codebook may be a collection of one or more codewords/precoding matrices.

Optionally, the first model is a CSI compression model based on artificial intelligence (AI).

Optionally, the first model is a CSI compression model that is not based on AI.

In some embodiments, the performance parameter is positively correlated or negatively correlated with performance for the first processing method and the second processing method.

Optionally, the performance parameter in the first processing method is positively correlated with the performance of the first processing method. The larger the performance parameter, the better the performance of the first processing method.

Optionally, the performance parameter in the first processing method is negatively correlated with the performance of the first processing method. The larger the performance parameter, the worse the performance of the first processing method.

In an example, the performance parameter is SGCS; and SGCS is positively correlated with the performance.

In an example, the performance parameter is NMSE; and NMSE is negatively correlated with the performance.

In some embodiments, the performance of the first processing method is worse than the first requirement, including at least one of the following:
the performance parameter in the first processing method is positively correlated with the performance of the first processing method, and the performance parameter is less than or equal to a performance threshold in the first requirement; or
the performance parameter in the first processing method is negatively correlated with the performance of the first processing method, and the performance parameter is greater than or equal to the performance threshold in the first requirement.

In the following, illustrations are provided in nine examples in combination with the fourth information in step S2102 or S2103 in the case where the performance parameter of the processing method is positively correlated with the performance of the processing method.

Example 1, the fourth information includes information for indicating a first time duration, where the first time duration corresponds to the first requirement.

The performance of the first processing method being worse than or equal to the first requirement includes:
a first number of times is greater than or equal to a first number threshold, or a ratio of the first number of times to the number of detections is greater than or equal to a first ratio threshold;
where the first number of times is the number of times that the performance parameter of the first processing method is less than or equal to a first performance threshold in multiple detections.

Example 2, the fourth information includes information for indicating a first value, where the first value is an integer greater than 1.

In response to the terminal 101 performing multiple detections on the performance of the first processing method (the number of the multiple detections is the first value), the performance of the first processing method being worse than or equal to the first requirement includes:
a second number of times is greater than or equal to a second number threshold, or a ratio of the second number of times to the total number of the multiple detections is greater than or equal to a second ratio threshold. The second number of times is the number of times that the performance parameter of the first processing method is less than or equal to the second performance threshold in the multiple detections.

Example 3, the fourth information includes information for indicating a second time duration and a second value, the second time duration and the second value corresponding to the first requirement, and the second value is an integer greater than 1.

In response to the terminal 101 performing detection on the performance of the first processing method, when the detection time duration reaches the second time duration or the number of detections reaches the second value, the detection on the performance parameters of the first processing method is stopped;
the performance of the first processing method being worse than or equal to the first requirement includes:
a third number of times is greater than or equal to a third number threshold, or a ratio of the third number of times to the second value is greater than or equal to a third ratio threshold.

Optionally, the third number of times is the number of times that the performance parameter of the first processing method is less than or equal to a third performance threshold in multiple detections before the detection on the performance parameter of the first processing method is stooped.

Example 4, the fourth information includes information for indicating a third time duration, where the third time duration corresponds to the second requirement.

In response to the terminal 101 performing multiple detections on the performance of the second processing method within the third time duration, the performance of the second processing method being better than or equal to the first requirement includes:
a fourth number of times is greater than or equal to a fourth number threshold, or a ratio of the fourth number of times to a total number of the multiple detections is greater than or equal to a fourth ratio threshold. Optionally, the fourth number of times is the number of times that the performance parameter of the second processing method is greater than or equal to a fourth performance threshold in the multiple detections.

Example 5, the fourth information includes information for indicating a third value, where the third value is an integer greater than 1.

In response to the terminal 101 performing multiple detections on the performance of the second processing method, the number of multiple detections being the third value, the performance of the second processing method being better than or equal to the first requirement includes:
a fifth number of times is greater than or equal to a fifth number threshold, or a ratio of the fifth number of times to the third value is greater than or equal to a fifth ratio threshold.

Optionally, the fifth number of times is the number of times that the performance parameter of the second processing method is greater than or equal to a fifth performance threshold in the multiple detections.

Example 6, the fourth information includes information for indicating a fourth time duration and a fourth value, the fourth time duration and the fourth value correspond to the second requirement, and the fourth value is an integer greater than 1.

In response to terminal 101 performing detection on the performance of the second processing method, when the detection time duration reaches the fourth time duration or the number of detections reaches the fourth value, the detection on the performance of the second CSI processing method is stooped; and the performance of the second processing method being better than or equal to the first requirement includes:
a sixth number of times is greater than or equal to a sixth number threshold, or a ratio of the sixth number of times to the fourth value is greater than or equal to a sixth ratio threshold.

Optionally, the sixth number of times is the number of times that the performance parameter of the second processing method is greater than or equal to the sixth performance threshold in multiple detections before the detection on the performance of the second processing method is stopped.

Example 7, the fourth information includes information for indicating a fifth time duration, where the fifth time duration corresponds to the third requirement.

In response to the terminal 101 performing multiple detections on the performance of the first processing method and the second processing method within the fifth time period, the performance of the first processing method being worse than or equal to the performance of one of the second processing methods includes:
a seventh number of times is greater than or equal to a seventh number threshold, or a ratio of the seventh number of times to a total number of the multiple detections is greater than or equal to a seventh ratio threshold.

Optionally, the seventh number of times is the number of times that the performance parameter of the first processing method is less than or equal to the performance parameter of the second processing method in multiple detections.

Example 8, the fourth information includes information for indicating a fifth value, where the fifth value corresponds to the third requirement and is an integer greater than 1.

In response to the terminal 101 performing multiple detections on the performance of the first processing method and the second processing method, the number of multiple detections being the fifth value, the performance of the first processing method being worse than or equal to the performance of one of the second processing methods includes:
an eighth number of times is greater than or equal to an eighth number threshold, or a ratio of the eighth number of times to the fifth value is greater than or equal to an eighth ratio threshold.

Optionally, the eighth number of times is the number of times that the performance parameter of the first processing method is less than or equal to the performance parameter of the second processing method in the multiple detections.

Example 9, the fourth information includes information for indicating a sixth time duration and a sixth value, where the sixth time duration and the sixth value correspond to the third requirement, and the sixth value is an integer greater than 1.

In response to terminal 101 performing detection on the performance of the first processing method and the second processing method, when the detection time duration reaches the sixth time duration or the number of detections reaches the sixth value, the detection on the performance of the first processing method and the second processing method is stopped, and the performance of the first processing method being worse than or equal to the performance of one of the second processing methods includes:
a ninth number of times is greater than or equal to a ninth number threshold, or a ratio of the ninth number of times to the sixth value is greater than or equal to a ninth ratio threshold.

Optionally, the ninth number of times is the number of times that the performance parameter of the first processing method is less than or equal to the performance parameter of the second processing method in the multiple detections.

In some embodiments, the first processing method processes the CSI based on a first model, and the difference in distribution between the first data and the second data of the first model is greater than a third requirement.

In some embodiments, the difference in the distribution between the first data and the second data is a first coefficient.

In some embodiments, the first coefficient is a correlation coefficient.

Optionally, the correlation coefficient is positively correlated with the difference in the distribution.

Optionally, a larger correlation coefficient corresponds to a smaller difference in the distribution, which corresponds to better performance of the first model.

Optionally, a smaller correlation coefficient corresponds to a larger difference in the distribution, which corresponds to worse performance of the first model.

Optionally, the correlation coefficient is used to describe the correlation between the first data and the second data.

Optionally, the correlation coefficient includes at least one of the following:
a standardized correlation coefficient, or a Kendall correlation coefficient.

In some embodiments, in the case of multi-layer transmission, the first condition includes at least one of the following:
the performance of the first processing method in at least one layer is worse than or equal to the first requirement;
the performance of any one of the at least one second processing method in at least one layer is better than or equal to the second requirement;
the performance of part of the at least one second processing method in at least one layer is better than or equal to the second requirement;
the performance of the first processing method in at least one layer is worse than or equal to the performance of any of the second processing methods in at least one layer;
the performance of the first processing method in at least one layer is worse than or equal to the performance of part of the second processing methods in at least one layer; or
the first processing method processes the CSI based on a first model, and a difference in distribution between first data and second data of the first model is greater than the third requirement.

In some embodiments, the threshold used to determine that the first condition is met corresponds to the at least one layer.

In an example, in a case where a rank in multi-layer transmission is greater than 1, the first condition includes at least one of the following:
the first processing method in layer 1 is worse than or equal to the first requirement;
the performance of any one of the at least one second processing method in layer 1 is better than or equal to the second requirement;
the performance of part of the at least one second processing method in layer 1 is better than or equal to the second requirement;
the performance of the first processing method in layer 1 is worse than or equal to the performance of any of the second processing methods in layer 1; or
the performance of the first processing method in layer 1 is worse than or equal to the performance of part of the second processing methods in layer 1.

Optionally, the threshold for determining that the first condition is met corresponds to layer 1.

In an example, in a case where the rank in the multi-layer transmission is greater than 1, the first condition includes at least one of the following:
the performance of the first processing method in layer 1 and layer 2 is worse than or equal to the first requirement;
the performance of any one of the at least one second processing method in layer 1 and layer 2 is better than or equal to the second requirement;
the performance of part of the at least one second processing method in layer 1 and layer 2 is better than or equal to the second requirement;
the performance of the first processing method in layer 1 is worse than or equal to the performance of any one of the second processing methods in layer 1 and layer 2; or
the performance of the first processing method in layer 1 is worse than or equal to the performance of part of the second processing method in layer 1 and layer 2.

Optionally, the threshold used to determine that the first condition is met includes: a threshold corresponding to layer 1 and a threshold corresponding to layer 2.

Step S2105, the terminal 101 sends first information.

In some embodiments, the first information is indication information.

In some embodiments, the first information is used to indicate a notification.

In some embodiments, the first information is notification indication information.

In some embodiments, the first information is used to indicate a trigger.

In some embodiments, the first information is trigger indication information.

In some embodiments, the network device 102 receives the first information.

In some embodiments, the first information indicates that the first condition is met.

Step S2106, the terminal 101 sends second information.

In some embodiments, the second information is indication information.

In some embodiments, the second information is used to indicate performance.

In some embodiments, the network device 102 receives the second information.

In some embodiments, the second information indicates the performance of the first processing method, or the second information indicates the performance of the first processing method and the performance of at least one second processing method.

In some embodiments, at least one of steps S2101 to S2106 may be performed. For example, step S2105 may be implemented as an independent embodiment; step S2101 plus step S2105 may be implemented as an independent embodiment; step S2102 plus step S2105 may be implemented as an independent embodiment; step S2105 plus step S2106 may be implemented as an independent embodiment; step S2101 plus step S2102 plus step S2105 may be implemented as an independent embodiment; step S2101 plus step S2103 plus step S2105 may be implemented as an independent embodiment; and step S2102 plus step S2104 plus step S2105 may be implemented as an independent embodiment.

In some embodiments, step S2101 and step S2102 may be performed in an interchanged order or simultaneously.

In some embodiments, step S2105 and step S2106 may be performed in an interchangeable order or simultaneously.

In some embodiments, when step S2101 and step S2102 are performed simultaneously, the information in step S2101 and step S2102 is sent through the same signaling, for example, the signaling is RRC signaling.

In some embodiments, step S2101, step S21012, step S2103, step S2104, and step S2106 are optional, and one or more of these steps may be omitted or replaced in different embodiments.

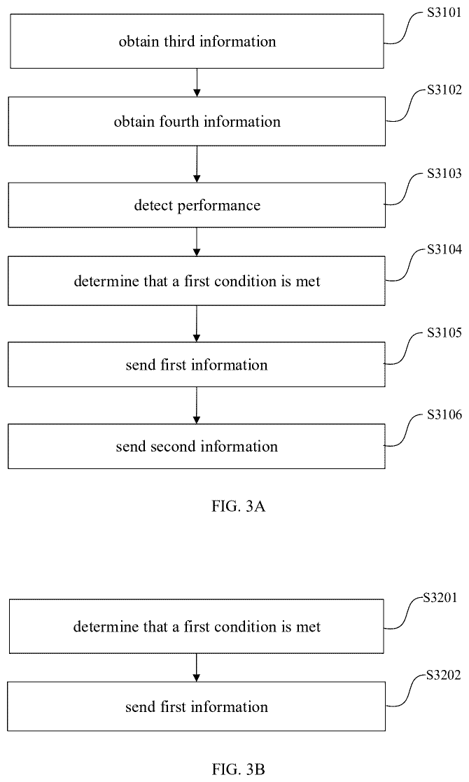

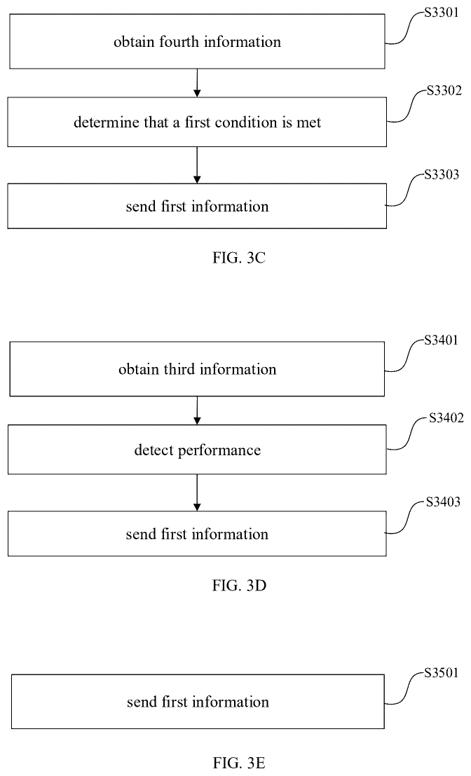

FIG. 3A is a flow chart of a communication method according to an embodiment of the present disclosure. As shown in FIG. 3A, the embodiment of the present disclosure relates to a communication method, which is performed by a terminal 101 and includes the following steps.

Step S3101, obtaining third information.

For the optional implementation of step S3101, reference may be made to the optional implementations of step S2101 in FIG. 2 and other related parts in the embodiment involved in FIG. 2, which will not be described in detail here.

In some embodiments, the terminal 101 receives the third information sent by the network device 102, but it is not limited thereto, and the terminal 101 may also receive the third information sent by other entities.

In some embodiments, the terminal 101 obtains the third information specified by a protocol.

In some embodiments, the terminal 101 obtains the third information from an upper layer(s).

In some embodiments, the terminal 101 performs processing to obtain the third information.

In some embodiments, step S3101 is omitted, and the terminal 101 autonomously implements the function indicated by the third information, or the above function is default or by default.

In some embodiments, “obtain”, “acquire”, “get”, “receive”, “transmit”, “send and/or receive” can be used interchangeably, which can be interpreted as receiving from other entities, obtaining from a protocol, obtaining by self-processing, autonomous implementation, etc.

Step S3102, obtaining fourth information.

For the optional implementation of step S3102, reference may be made to the optional implementation of step S2102 in FIG. 2 and other related parts in the embodiment involved in FIG. 2, which will not be repeated here.

In some embodiments, the terminal 101 receives the fourth information sent by the network device 102, but it is not limited thereto, and the terminal 101 may also receive the fourth information sent by other entities.

In some embodiments, terminal 101 obtains fourth information specified by a protocol.

In some embodiments, the terminal 101 obtains the fourth information from an upper layer(s).

In some embodiments, the terminal 101 performs processing to obtain the fourth information.

In some embodiments, step S3101 is omitted, and the terminal 101 autonomously implements the function indicated by the fourth information, or the above function is default or by default.

Step S3103, the terminal 101 detects performance.

For the optional implementation of step S3103, reference may be made to the optional implementation of step S2103 in FIG. 2 and other related parts in the embodiment involved in FIG. 2, which will not be repeated here.

Step S3104, the terminal 101 determines that a first condition is met.

For the optional implementation of step S3104, reference may be made to the optional implementation of step S2104 in FIG. 2 and other related parts in the embodiment involved in FIG. 2, which will not be repeated here.

Step S3105, the terminal 101 sends first information.

For the optional implementation of step S3105, reference may be made to the optional implementation of step S2105 in FIG. 2 and other related parts in the embodiment involved in FIG. 2, which will not be repeated here.

Step S3106, the terminal 101 sends second information.

For the optional implementation of step S3106, reference may be made to the optional implementation of step S2106 in FIG. 2 and other related parts in the embodiment involved in FIG. 2, which will not be repeated here.

In some embodiments, at least one of steps S3101 to S3106 may be performed. For example, step S3105 may be implemented as an independent embodiment; step S3104 plus step S3105 may be implemented as an independent embodiment; step S3101 plus step S3105 may be implemented as an independent embodiment; step S3102 plus step S3105 may be implemented as an independent embodiment; step S3101 plus step S3103 plus step S3105 may be implemented as an independent embodiment; and step S3102 plus step S3104 plus step S3105 may be implemented as an independent embodiment.

In some embodiments, step S3101 and step S3102 may be performed in an interchanged order or simultaneously.

In some embodiments, step S3105 and step S3106 may be performed in an interchanged order or simultaneously.

In some embodiments, when step S3101 and step S3102 are performed simultaneously, the information in step S3101 and step S3102 is sent through the same signaling, for example, the signaling is RRC signaling.

In some embodiments, step S3101, step S31012, step S3103, step S3104, and step S3106 are optional, and one or more of these steps may be omitted or replaced in different embodiments.

FIG. 3B is a flow chart of a communication method according to an embodiment of the present disclosure. As shown in FIG. 3B, the embodiment of the present disclosure relates to a communication method, which is performed by the terminal 101 and includes the following steps.

Step S3201, determining that a first condition is met.

For optional implementations of step S3201, reference may be made to the optional implementations of step S2104 in FIG. 2 and S3104 in FIG. 3A, and other related parts in the embodiments involved in FIG. 2 and FIG. 3A, which will not be repeated here.

Step S3202, sending first information.

For optional implementations of step S3202, reference may be made to the optional implementations of step S2105 in FIG. 2 and S3105 in FIG. 3A, and other related parts in the embodiments involved in FIG. 2 and FIG. 3A, which will not be described in detail here.

In some embodiments, at least one of steps S3201 to S3202 may be performed. For example, step S3202 may be implemented as an independent embodiment, but it is not limited thereto.

In some embodiments, step S3201 is optional, and one or more of these steps may be omitted or replaced in different embodiments.

In the embodiments of the present disclosure, step S3202 can be combined with step S3101 of FIG. 3A; step S3202 can be combined with step S3102 of FIG. 3A; step S3202 can be combined with step S3101 and step S3103 of FIG. 3A; step S3202 can be combined with step S3102 and step S310 of FIG. 3A.

FIG. 3C is a flow chart of a communication method according to an embodiment of the present disclosure. As shown in FIG. 3C, the embodiment of the present disclosure relates to a communication method, which is performed by the terminal 101 and includes the following steps.

Step S3301, obtaining fourth information.

For optional implementations of step S3301, reference may be made to the optional implementations of step S2102 in FIG. 2 and S3102 in FIG. 3A, and other related parts in the embodiments involved in FIG. 2 and FIG. 3A, which will not be repeated here.

Step S3302, determining that a first condition is met.

For optional implementations of step S3302, reference may be made to the optional implementations of step S2104 in FIG. 2 and S3104 in FIG. 3A, and other related parts in the embodiments involved in FIG. 2 and FIG. 3A, which will not be repeated here.

Step S3303, sending first information.

For optional implementations of step S3303, reference may be made to the optional implementations of step S2105 in FIG. 2 and S3105 in FIG. 3A, and other related parts in the embodiments involved in FIG. 2 and FIG. 3A, which will not be repeated here.

In some embodiments, at least one of steps S3301 to S3303 may be performed. For example, step S3303 may be implemented as an independent embodiment; step S3301 and step S3303 may be implemented as independent embodiments; but it is not limited thereto.

In some embodiments, step S3301 and step S3302 are optional, and one or more of these steps may be omitted or replaced in different embodiments.

In the embodiments of the present disclosure, step S3303 can be combined with step S3101 of FIG. 3A.

FIG. 3D is a flow chart of a communication method according to an embodiment of the present disclosure. As shown in FIG. 3D, the embodiment of the present disclosure relates to a communication method, which is performed by the terminal 101 and includes the following steps.

Step S3401, obtaining third information.

For optional implementations of step S3401, reference may be made to the optional implementation of step S2101 in FIG. 2 and S3101 in FIG. 3A, and other related parts in the embodiments involved in FIG. 2 and FIG. 3A, which will not be repeated here.

Step S3402, detecting performance.

For optional implementations of step S3402, reference may be made to the optional implementation of step S2103 in FIG. 2 and S3103 in FIG. 3A, and other related parts in the embodiments involved in FIG. 2 and FIG. 3A, which will not be repeated here.

Step S3403, sending first information.

For optional implementations of step S3403, reference may be made to the optional implementation of step S2105 in FIG. 2 and S3105 in FIG. 3A, and other related parts in the embodiments involved in FIG. 2 and FIG. 3A, which will not be repeated here.

In some embodiments, at least one of steps S3401 to S3403 may be performed. For example, step S3403 may be implemented as an independent embodiment, but it is not limited thereto.

In some embodiments, step S3401 and step S3402 are optional, and one or more of these steps may be omitted or replaced in different embodiments.

In the embodiment of the present disclosure, step S3403 can be combined with step S3102 of FIG. 3A. Step S3403 can be combined with step S3104 of FIG. 3A.

FIG. 3E is a flow chart of a communication method according to an embodiment of the present disclosure. As shown in FIG. 3E, the embodiment of the present disclosure relates to a communication method, which is performed by the terminal 101 and includes the following steps.

Step S3501, sending first information.

In some embodiments, the first information indicates that a first condition is met, and the first condition is determined according to at least one of the following:
performance of a first processing method; or
performance of at least one second processing method.

Optionally, the first processing method is used for channel state information (CSI) reporting, and the second processing method is used for performance monitoring.

In some embodiments, the performance of the first processing method is worse than or equal to a first requirement;
the performance of any one of at least one second processing method is better than or equal to a second requirement;
the performance of part of the at least one second processing method is better than or equal to the second requirement;
the performance of the first processing method is worse than or equal to the performance of any of the second processing methods;
the performance of the first processing method is worse than or equal to the performance of part of the second processing methods;
the first processing method processes CSI based on a first model, and a difference in distribution between first data and second data of the first model is greater than a third requirement.

In some embodiments, the first processing method processes the CSI based on the first model;
the second CSI processing method processes the CSI based on a second model, or the second CSI processing method processes CSI based on a codebook. The first model and the second model are different.

In some embodiments, it further includes: sending second information; the second information indicates the performance of the first processing method, or the second information indicates the performance of the first processing method and the performance of the at least one second processing method.

In some embodiments, it further includes:
receiving third information, where the third information includes information for configuring a CSI downlink reference signal, and the information for configuring the CSI downlink reference signal is used to determine at least one of the following:
the performance of the first processing method; or
the performance of the at least one second processing method.

In some embodiments, it further includes:
receiving fourth information, where the fourth information includes information for indicating a threshold.

In some embodiments, the fourth information includes at least one of the following:
at least one first threshold; or
at least one second threshold.

The at least one first threshold value is used for the first requirement, and the at least one second threshold value is used for the second requirement.

In some embodiments, the performance of the first processing method includes: the performance of the first processing method in at least one layer; and
the performance of the second processing method includes: the performance of the second processing method in at least one layer;
where the layer is a layer in multi-layer transport.

In some embodiments, the first threshold corresponds to at least one layer; and
the second threshold corresponds to at least one layer.

In some embodiments, the performance includes at least one of the following:
a square of generalized cosine similarity (SGCS);
a normalized mean square error (NMSE);
a generalized cosine similarity (GCS); or
an assumed block error rate.

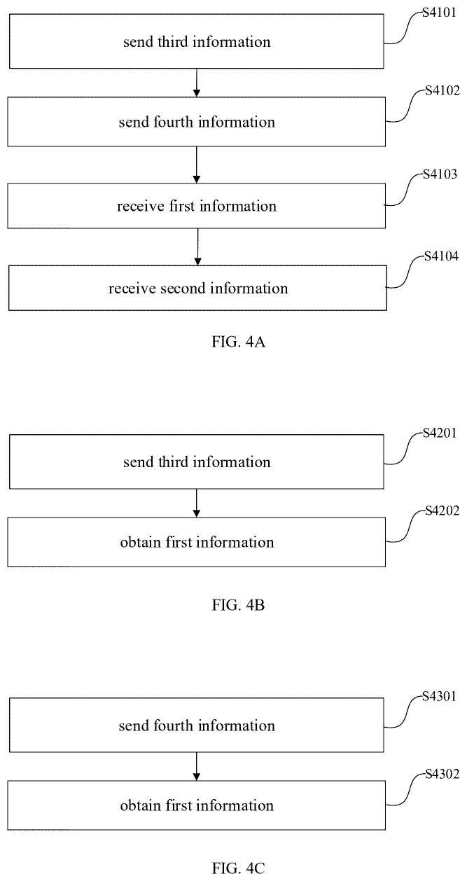

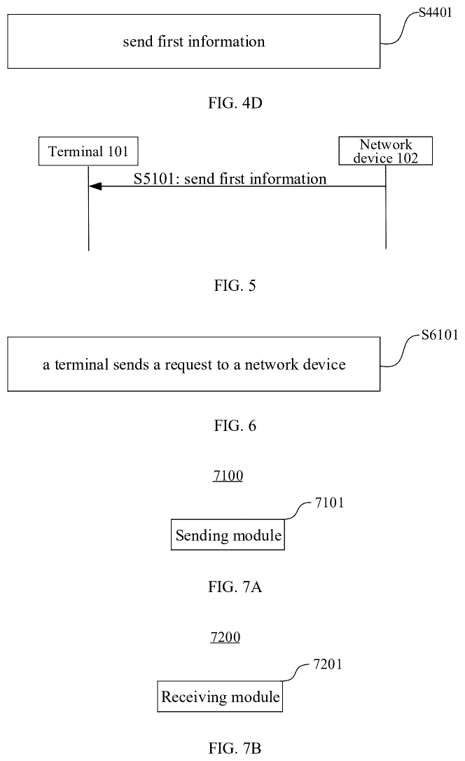

FIG. 4A is a flow chart of a communication method according to an embodiment of the present disclosure. As shown in FIG. 4A, the embodiment of the present disclosure relates to a communication method, which is performed by a network device 102 and includes the following steps.

Step S4101, sending third information.

In some embodiments, the network device 102 sends the third information to the terminal 101, but it is not limited thereto, and the network device 102 may also send the third information to other entities.

Optionally, the third information is used for performing configuration by the terminal 101. For optional implementations thereof, reference may be made to the optional implementations of step S2101 in FIG. 2 and other related parts of the embodiment involved in FIG. 2, which will not be described in detail here.

Step S4102, sending fourth information.

In some embodiments, the network device 102 sends the fourth information to the terminal 101, but it is not limited thereto, and the network device 102 may also send the fourth information to other entities.

Optionally, the fourth information is used for performing configuration by the terminal 101. For optional implementations thereof, reference may be made to the optional implementations of step S2101 in FIG. 2 and other related parts of the embodiment involved in FIG. 2, which will not be described in detail here.

Step S4103, receiving first information.

In some embodiments, the network device 102 receives the first information sent by the terminal 101, but it is not limited thereto, and the network device 102 may also receive the first information sent by other entities.

In some embodiments, the network device 102 obtains the first information specified by a protocol.

In some embodiments, the network device 102 obtains the first information from an upper layer(s).

In some embodiments, the network device 102 performs processing to obtain the first information.

In some embodiments, step S4103 is omitted, and the network device 102 autonomously implements the function indicated by the first information, or the above function is default or by default.

Step S4104, receiving second information.

In some embodiments, the network device 102 receives the second information sent by the terminal 101, but it is not limited thereto, and the network device 102 may also receive the first information sent by other entities.

In some embodiments, the network device 102 obtains the second information specified by a protocol.

In some embodiments, the network device 102 obtains the second information from an upper layer(s).

In some embodiments, the network device 102 performs processing to obtain the second information.

In some embodiments, step S4104 is omitted, and the network device 102 autonomously implements the function indicated by the second information, or the above function is default or by default.

In some embodiments, at least one of steps S4101 to S4104 may be performed. For example, step S4103 may be implemented as an independent embodiment; step S4103 plus step S4104 may be implemented as independent embodiments; step S4101 plus step S4103 may be implemented as independent embodiments; step S4102 plus step S4103 may be implemented as independent embodiments; and step S4101 plus step S4102 plus step S4103 may be implemented as independent embodiments; but it is not limited thereto.

In some embodiments, step S4101 and step S4102 may be performed in an interchanged order or simultaneously.

In some embodiments, step S4105 and step S4106 may be performed in an interchanged order or simultaneously.

In some embodiments, when step S4101 and step S4102 are performed simultaneously, the information in step S4101 and step S4102 is sent through the same signaling, for example, the signaling is RRC signaling.

In some embodiments, step S3101, step S31012, and step S3104 are optional, and one or more of these steps may be omitted or replaced in different embodiments.

FIG. 4B is a flow chart of a communication method according to an embodiment of the present disclosure. As shown in FIG. 4B, the embodiment of the present disclosure relates to a communication method, which is performed by a network device 102 and includes:

Step S4201, sending third information.

For the optional implementation of step S4202, reference may be made to the optional implementation of step S2101 in FIG. 2 and S4101 in FIG. 4A, and other related parts in the embodiments involved in FIG. 2 and FIG. 4A, which will not be repeated here.

Step S4202, obtaining first information.

For optional implementations of step S4202, reference may be made to the optional implementations of step S2105 in FIG. 2 and step S4105 in FIG. 4A, and other related parts in the embodiments involved in FIG. 2 and FIG. 4A, which will not be repeated here.

In some embodiments, at least one of steps S4201 to S4202 may be performed. For example, step S4202 may be implemented as an independent embodiment, but it is not limited thereto.

In some embodiments, step S4201 is optional, and one or more of these steps may be omitted or replaced in different embodiments.

FIG. 4C is a flow chart illustrating a communication method according to an embodiment of the present disclosure. As shown in FIG. 4C, the embodiment of the present disclosure relates to a communication method, which is performed by a network device 102 and includes the following steps.

Step S4301, sending fourth information.

For optional implementations of step S4301, reference may be made to the optional implementation of step S2103 in FIG. 2 and S4301 in FIG. 4A, and other related parts in the embodiments involved in FIG. 2 and FIG. 4A, which will not be repeated here.

Step S4302, obtaining first information.

For optional implementations of step S4302, reference may be made to the optional implementations of step S2105 in FIG. 2, and S4105 in FIG. 4A, and other related parts in the embodiments involved in FIG. 2 and FIG. 4A, which will not be repeated here.

In some embodiments, at least one of steps S4301 to S4302 may be performed. For example, step S4302 may be implemented as an independent embodiment, but it is not limited thereto.

In some embodiments, step S4301 is optional, and one or more of these steps may be omitted or replaced in different embodiments.

FIG. 4D is a flow chart of a communication method according to an embodiment of the present disclosure. As shown in FIG. 4D, the embodiment of the present disclosure relates to a communication method, which is performed by a network device 102 and includes the following steps.

Step S4401, sending first information.

In some embodiments, the first information indicates that a first condition is met, and the first condition is determined according to at least one of the following:
performance of a first processing method; or
performance of at least one second processing method.

Optionally, the first processing method is used for channel state information (CSI) reporting, and the second processing method is used for performance monitoring.

In some embodiments, the first condition includes at least one of the following:
the performance of the first processing method is worse than or equal to a first requirement;
the performance of any one of the at least one second processing method is better than or equal to a second requirement;
the performance of part of the at least one second processing method is better than or equal to the second requirement;
the performance of the first processing method is worse than or equal to the performance of any one of the second processing methods;
the performance of the first processing method is worse than or equal to the performance of part of the second processing methods; or
the first processing method processes the CSI based on a first model, and a difference in distribution between first data and second data of the first model is greater than a third requirement.

In some embodiments, the first processing method processes the CSI based on the first model;
the second CSI processing method processes the CSI based on a second model, or the second CSI processing method processes the CSI based on a codebook; and the first model and the second model are different.

In some embodiments, second information is received; the second information indicates the performance of the first processing method, or the second information indicates the performance of the first information processing method and the performance of the at least one second processing method.

In some embodiments, third information is sent, where the third information includes information for configuring a CSI downlink reference signal, and the information for configuring the CSI downlink reference signal is used to determine at least one of the following:
the performance of the first processing method; or
the performance of the at least one second processing method.

In some embodiments, fourth information is sent, and the fourth information includes information for indicating a threshold.

In some embodiments, the fourth information includes at least one of the following:
at least one first threshold; or
at least one second threshold.

The at least one first threshold is used for the first requirement, and the at least one second threshold is used for the second requirement.

In some embodiments, the performance of the first processing method includes: the performance of the first processing method in at least one layer; and
the performance of the second processing method includes: the performance of the second processing method in at least one layer;
where the layer is a layer in multi-layer transmission.

In some embodiments, the first threshold corresponds to the at least one layer; and the second threshold corresponds to the at least one layer.

In some embodiments, the performance includes at least one of the following:
a square of generalized cosine similarity (SGCS);
a normalized mean square error (NMSE);
a generalized cosine similarity (GCS); or
an assumed block error rate.

FIG. 5 is a flow chart of a communication method according to an embodiment of the present disclosure. As shown in FIG. 5, the embodiment of the present disclosure relates to a communication method for a communication system 100, the method including the following steps.

Step S5101, a terminal 101 sends first information to a network device 102.

In some embodiments, the first information indicates that a first condition is met, and the first condition is determined according to at least one of the following:
performance of a first processing method; or
performance of at least one second processing method;
where the first processing method is used for channel state information (CSI) reporting, and the second processing method is used for performance monitoring.

For optional implementations of step S5101, reference may be made to optional implementations of step S2105 in FIG. 2, step S3105 in FIG. 3, step S4105 in FIG. 4, and other related parts in the embodiments involved in FIG. 2, FIG. 3, and FIG. 4, which will not be described in detail here.

In some embodiments, the method may include the methods of the embodiments for the communication system side, the terminal side, the network device side, etc., which will not be repeated here.

FIG. 6 is a flow chart of a communication method according to an embodiment of the present disclosure. As shown in FIG. 6, the embodiment of the present disclosure relates to a communication method for a communication system 100, the method including the following steps.

Step S6101, a terminal 101 sends a request to a network device 102.

In some embodiments, the request is determined based on a pre-defined condition.

In some embodiments, the terminal determines that the predefined condition occurs and sends the request to the network device 102.

In some embodiments, the request indicates that a predefined condition occurs.

In some embodiments, the request further indicates index information, and the index information corresponds to a predefined condition.

Optionally, the index information is a sequence number.

Optionally, the sequence number is one of multiple sequence numbers, and the multiple sequence numbers correspond to multiple predefined conditions.

In an example, there are four different predefined conditions, and the index information occupies 2 bits.

Optionally, a value indicated by the 2 bits can indicate any one of the four different predefined conditions.

In some embodiments, the predefined condition includes at least one of the following:
condition 1, performance of the currently used AI model is poor;
condition 2, at least one candidate CSI calculation method has good performance; or
condition 3, the performance of the currently used AI model is worse than the performance of at least one candidate CSI calculation method.

In condition 1, the performance of the currently used AI model being poor includes: first data is used for inference in the currently used AI model, and second data is used for training in the currently used AI model.

In some embodiments, the candidate CSI calculation method uses a candidate AI model.

Optionally, the candidate AI model is configured by the network device or is a predefined default AI model.

Optionally, the network device sends a CSI reporting configuration to the terminal, where the CSI reporting configuration includes a CSI reporting configuration identification (CSI report configuration ID), and the CSI report configuration ID corresponds to the AI model.

In some embodiments, the performance of the AI model may be a similarity level. The similarity level is determined by the terminal based on the measured channel state information and the output result of the proxy encoder. The proxy encoder is configured in the terminal.

Optionally, the similarity level is obtained by estimating a hypothetical PDCCH by the terminal according to a downlink reference signal.

Optionally, the similarity level is SGCS or BLER.

In an example, the condition 1 includes: within a period of time, for example, within a time duration corresponding to a timer configured by RRC, the SGCS of the AI model monitored by the terminal is lower than a threshold for more than X times, or a ratio (i.e., a ratio of the number of times for being lower than the threshold to the total number of times of monitoring) exceeds Y %. Optionally, the threshold may be a threshold configured through RRC signaling (RRC configured SGCS threshold).

Optionally, the values of X and Y may be configured through RRC information, or may be preset by default.

In an example, the condition 2 includes: within a period of time, for example, within a time duration corresponding to a timer configured by RRC, the SGCS of the AI model monitored by the terminal is higher than the threshold for more than X times, or the ratio (i.e., the ratio of the number of times for being higher than the threshold to the total number of times of monitoring) exceeds Y %. Optionally, the threshold can be a threshold configured through RRC signaling (RRC configured SGCS threshold).

Optionally, the values of X and Y may be configured through RRC information, or may be preset by default.

In an example, the condition 3 includes: with the currently used AI model being called A and the candidate CSI calculation method being called B, within a period of time, the number of times that the SGCS of A monitored by the terminal is lower than the SGCS of B exceeds X times, or the ratio (i.e., the ratio of the number of times for being higher than the threshold to the total number of times of monitoring) exceeds Y %. Optionally, the threshold can be a threshold configured through RRC signaling (RRC configured SGCS threshold).

Optionally, the values of X and Y may be configured through RRC information, or be preset by default.

In some embodiments, in the case where rank>1 and the performance parameter is SGCS, the SGCS may be calculated based on different layers, i.e., different layers have different SGCS values. The predefined condition related to the performance may be assumed to be for layer 1 by default, i.e., the UE understands that:
the layer 1 performance of the currently used AI model is poor;
the layer 1 performance based on the candidate CSI calculation method is good;
the layer 1 performance of the currently used AI model is worse than the layer 1 performance based on the candidate CSI calculation method.

Optionally, the threshold only needs to be defined for one layer.

In some embodiments, the predefined condition related to the performance may be for layer 1 and layer 2 by default, that is, the UE understands that:
the layer 1 and layer 2 performance of the currently used AI model are poor;
the layer 1 and layer 2 performance of the currently used AI model are poor, while the layer 1 and layer 2 performance based on the candidate CSI calculation method are good;
the layer 1 and layer 2 performance of the currently used AI model is worse than the layer 1 and layer 2 performance based on the candidate CSI calculation method.

In the embodiments of the present disclosure, before step S6101, it further includes that the network device configures a downlink reference signal for the terminal (the downlink reference signal includes a CSI-SR). The terminal calculates the performance of the currently used AI model and/or the performance of at least one candidate CSI calculation method based on the downlink reference signal.

The embodiments of the present disclosure also provide an apparatus for implementing any of the above methods. For example, an apparatus is provided, including units or modules for implementing the steps performed by the terminal in any of the above methods. For another example, another apparatus is provided, including units or modules for implementing the steps performed by the network device (e.g., an access network device, a core network function node, a core network device, etc.) in any of the above methods.

It should be understood that the division of the various units or modules in the above apparatus is merely a division of logical functions, and in actual implementations, they may be fully or partially integrated into a single physical entity, or may be physically separate. Furthermore, the units or modules in the apparatus may be implemented in the form of a processor invoking software, for example, the apparatus may include a processor connected to a memory having stored therein instructions, and the processor invokes the instructions stored in the memory to implement any of the above methods or the functions of the various units or modules in the apparatus. The processor may be, for example, a general-purpose processor such as a central processing unit (CPU) or a microprocessor, and the memory may be a memory internal or external to the apparatus. Alternatively, the units or modules in the apparatus may be implemented in the form of hardware circuits, and the functions of some or all of the units or modules may be realized through the design of the hardware circuits. The hardware circuits may be understood as one or more processors. For example, in an implementation, the hardware circuits are application-specific integrated circuits (ASICs), and the functions of some or all of the above units or modules are realized through the design of the logical relationships between the components within the circuits. In another implementation, the hardware circuits may be implemented using programmable logic devices (PLDs). Using a field programmable gate array (FPGA) as an example, it may include a large number of logic gate circuits. The connection relationship between the logic gates are configured through configuration files, thereby realizing the functions of some or all of the above units or modules. All units or modules of the above apparatuses may be implemented entirely through a processor invoking software, entirely through hardware circuits, or partially through a processor invoking software with the remainder implemented through hardware circuits.

In the embodiments of the present disclosure, a processor is a circuit with signal processing capabilities. In an implementation, the processor can be a circuit capable of reading and executing instructions, such as a central processing unit (CPU), a microprocessor, a graphics processing unit (GPU) (which can be understood as a type of microprocessor), or a digital signal processor (DSP). In another implementation, the processor can implement certain functions through the logical relationships of hardware circuits. The logical relationships of the hardware circuits are fixed or reconfigurable. For example, the processor can be a hardware circuit implemented by an application-specific integrated circuit (ASIC) or a programmable logic device (PLD), such as an FPGA. In a reconfigurable hardware circuit, the process of the processor loading a configuration file to implement the hardware circuit configuration can be understood as the process of the processor loading instructions to implement the functions of some or all of the above units or modules. In addition, it can also be a hardware circuit designed for artificial intelligence, which can be understood as an ASIC, such as a neural network processing unit (NPU), a tensor processing unit (TPU), a deep learning processing unit (DPU), etc.

FIG. 7A is a structural schematic diagram of a first communication apparatus provided by an embodiment of the present disclosure. As shown in FIG. 7A, the first communication apparatus 7100 includes: a sending module 7101, configured to send first information, the first information indicates that a first condition is met, the first condition is determined based on at least one of the following: performance of a first processing method; or performance of at least one second processing method; where the first processing method is used for channel state information (CSI) reporting, and the second processing method is used for performance monitoring. Optionally, the above sending module 7101 is configured to perform the steps related to sending performed by the terminal 101 in any of the above methods, which are not repeated here. Optionally, the first communication apparatus 7100 also includes at least one of a receiving module and a detection module; the receiving module is configured to perform the steps related to receiving performed by the terminal 101 in any of the above methods; and the detection module is configured to perform the steps related to detection performed by the terminal 101 in any of the above methods, which are not repeated here.

FIG. 7B is a structural schematic diagram of a second communication apparatus provided in an embodiment of the present disclosure. As shown in FIG. 7B, the second communication apparatus 7200 includes: a receiving module 7201, configured to receive first information, where the first information indicates that a first condition is met, the first condition is determined based on at least one of the following: performance of a first processing method; or the performance of at least one second processing method; the first processing method is used for channel state information (CSI) reporting, and the second processing method is used for performance monitoring. Optionally, the receiving module 7201 is configured to perform the steps related to reception performed by the network device 102 in any of the above methods, which are not repeated here. Optionally, the second communication apparatus 7200 also includes a sending module; and the sending module is configured to perform the steps related to sending performed by the network device 102 in any of the above methods, which are not repeated here.

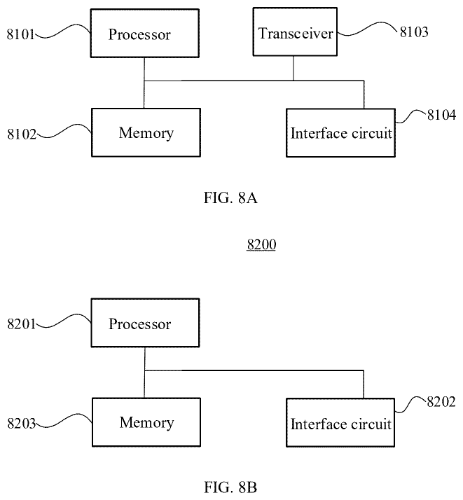

FIG. 8A is a structural schematic diagram of a communication device 8100 provided in an embodiment of the present disclosure. The communication device 8100 can be a network device (e.g., an access network device, a core network device, etc.), or a terminal (e.g., a user equipment, etc.), or a chip, chip system, or processor that supports the network device implementing any of the above methods, or a chip, chip system, or processor that supports the terminal implementing any of the above methods. The communication device 8100 can be configured to implement the methods described in the above method embodiments. For details, please refer to the description of the above method embodiments.

As shown in FIG. 8A, the communication device 8100 includes one or more processors 8101. The processor 8101 can be a general-purpose processor or a dedicated processor, for example, a baseband processor or a central processor. The baseband processor can be configured to perform processing on communication protocols and communication data, while the central processor can be configured to perform control on the communication apparatus (e.g., a base station, a baseband chip, a terminal device, a terminal device chip, a DU or a CU), execute programs, and process program data. The processor 8101 is configured to invoke instructions to cause the communication device 8100 to perform any of the above methods.

In some embodiments, the communication device 8100 further includes one or more memories 8102 for storing instructions. Optionally, all or part of the memories 8102 may also be located outside the communication device 8100.

In some embodiments, the communication device 8100 further includes one or more transceivers 8103. When the communication device 8100 includes one or more transceivers 8103, the communication steps such as sending and receiving in the above method are performed by the transceivers 8103, and the other steps are performed by the processor 8101.

In some embodiments, the transceiver may include a receiver and a transmitter, which may be separate or integrated together. Optionally, the terms transceiver, transceiving unit, transceiving machine, and transceiving circuit may be used interchangeably; the terms transmitter, transmitting unit, transmitting machine, and transmitting circuit may be used interchangeably; and the terms receiver, receiving unit, receiving machine, and receiving circuit may be used interchangeably.

Optionally, the communication device 8100 further includes one or more interface circuits 8104, which are connected to the memory 8102. The interface circuits 8104 can be configured to receive signals from the memory 8102 or other devices, and can be configured to send signals to the memory 8102 or other devices. For example, the interface circuits 8104 can read instructions stored in the memory 8102 and send the instructions to the processor 8101.

The communication device 8100 described in the above embodiments can be a network device or a terminal, but the scope of the communication device 8100 described in the present disclosure is not limited thereto, and the structure of the communication device 8100 may not be limited by FIG. 8A. The communication device may be an independent device or may be part of a larger device. For example, the communication device may be: (1) an independent integrated circuit IC, or chip, or chip system or subsystem; (2) a collection of one or more ICs, optionally, the IC collection may also include a storage component for storing data and programs; (3) an ASIC, such as a modem; (4) a module that can be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc.; (6) others, etc.

FIG. 8B is a structural schematic diagram of a chip 8200 provided in an embodiment of the present disclosure. For the communication device 8100 which may be a chip or a chip system, please refer to the structural schematic diagram of a chip 8200 shown in FIG. 8B, but it is not limited thereto. The chip 8200 includes one or more processors 8201, which are configured to invoke instructions to cause the chip 8200 to perform any of the above methods.

In some embodiments, the chip 8200 further includes one or more interface circuits 8202, and the interface circuits 8202 are connected to a memory 8203 and can be configured to receive signals from the memory 8203 or other devices, or to send signals to the memory 8203 or other devices. For example, the interface circuit 8202 can read instructions stored in memory 8203 and send the instructions to the processor 8201. Optionally, the terms interface circuit, interface, transceiving pin, and transceiver are interchangeable.

In some embodiments, the chip 8200 further includes one or more memories 8203 for storing instructions. Optionally, all or part of the memories 8203 may be located outside the chip 8200.

The present disclosure also provides a storage medium having instructions stored thereon, and when the instructions are executed on the communication device 8100, the communication device 8100 is caused to perform any of the above methods. Optionally, the storage medium is an electronic storage medium. Optionally, the storage medium is a computer-readable storage medium, but is not limited to this and may also be a storage medium readable by other devices. Optionally, the storage medium may be a non-transitory storage medium, but is not limited to this and may also be a transitory storage medium.

The present disclosure also provides a program product which, when being executed by the communication device 8100, causes the communication device 8100 to perform any of the above methods. Optionally, the program product is a computer program product.

The present disclosure also provides a computer program which, when being executed on a computer, causes the computer to perform any one of the above methods.

1. A communication method, performed by a terminal, the method comprising:
sending first information, wherein the first information indicates that a first condition is met, and the first condition is determined according to at least one of:
performance of a first processing method; or
performance of at least one second processing method; and
wherein the first processing method is used for channel state information (CSI) reporting, and the second processing method is used for performance monitoring.

2. The method according to claim 1, wherein the first condition comprises at least one of:
the performance of the first processing method is worse than or equal to a first requirement;
the performance of any one of the at least one second processing method is better than or equal to a second requirement;
the performance of part of the at least one second processing method is better than or equal to the second requirement;
the performance of the first processing method is worse than or equal to the performance of any one of the at least one second processing method;
the performance of the first processing method is worse than or equal to the performance of part of the at least one second processing method; or
the first processing method processes CSI based on a first model, and a difference in distribution between first data and second data of the first model is greater than a third requirement.

3. The method according to claim 1, wherein,
the first processing method processes CSI based on a first model;
the second processing method processes the CSI based on a second model, or the second processing method processes the CSI based on a codebook; and
wherein the first model and the second model are different.

4. The method according to claim 1, further comprising:
sending second information;
wherein the second information indicates the performance of the first processing method, or the second information indicates the performance of the first processing method and the performance of the at least one second processing method.

5. The method according to claim 1, further comprising:
receiving third information, wherein the third information comprises information for configuring a CSI downlink reference signal, and the information for configuring the CSI downlink reference signal is used to determine at least one of:
the performance of the first processing method; or
the performance of the at least one second processing method.

6. The method according to claim 2, further comprising:
receiving fourth information, wherein the fourth information comprises information for indicating a threshold.

7. The method according to claim 6, wherein the fourth information comprises at least one of:
at least one first threshold; or
at least one second threshold;
wherein the at least one first threshold is used for the first requirement, and the at least one second threshold is used for the second requirement.

8. The method according to claim 1, wherein,
the performance of the first processing method comprises the performance of the first processing method in at least one layer;
the performance of the second processing method comprises: the performance of the second processing method in at least one layer; and
the layer is a layer in multi-layer transmission.

9. The method according to claim 8, wherein,
the first threshold corresponds to the at least one layer; and
the second threshold corresponds to the at least one layer.

10. The method according to claim 1, wherein the performance comprises at least one of:
a square of generalized cosine similarity (SGCS);
a normalized mean square error (NMSE);
a generalized cosine similarity (GCS); or
an assumed block error rate.

11. A communication method, performed by a network device, the method comprising:
receiving first information, wherein the first information indicates that a first condition is met, and the first condition is determined according to at least one of:
performance of a first processing method; or
performance of at least one second processing method;
wherein the first processing method is used for channel state information (CSI) reporting, and the second processing method is used for performance monitoring.

12. The method according to claim 11, wherein the first condition comprises at least one of:
the performance of the first processing method is worse than or equal to a first requirement;
the performance of any one of the at least one second processing method is better than or equal to a second requirement;
the performance of part of the at least one second processing method is better than or equal to the second requirement;
the performance of the first processing method is worse than or equal to the performance of any one of the at least one second processing method;
the performance of the first processing method is worse than or equal to the performance of part of the at least one second processing method; or
the first processing method processes CSI based on a first model, and a difference in distribution between first data and second data of the first model is greater than a third requirement.

13. The method according to claim 11, wherein,
the first processing method processes CSI based on a first model;
the second processing method processes the CSI based on a second model, or the second processing method processes the CSI based on a codebook; and
wherein the first model and the second model are different.

14. The method according to claim 11, further comprising:
receiving second information;
wherein the second information indicates the performance of the first processing method, or the second information indicates the performance of the first processing method and the performance of the at least one second processing method.

15. The method according to claim 11, further comprising:
sending third information, wherein the third information comprises information for configuring a CSI downlink reference signal, and the information for configuring the CSI downlink reference signal is used to determine at least one of:
the performance of the first processing method; or
the performance of the at least one second processing method.

16. The method according to claim 12, further comprising:
sending fourth information, wherein the fourth information comprises information for indicating a threshold.

17. The method according to claim 16, wherein the fourth information comprises at least one of:
at least one first threshold; or
at least one second threshold;
wherein the at least one first threshold is used for the first requirement, and the at least one second threshold is used for the second requirement.

18. The method according to claim 11, wherein,
the performance of the first processing method comprises the performance of the first processing method in at least one layer;
the performance of the second processing method comprises the performance of the second processing method in at least one layer; and
the layer is a layer in multi-layer transmission,
wherein,
the first threshold corresponds to the at least one layer; and
the second threshold corresponds to the at least one layer.

19-21. (canceled)

22. A terminal device, comprising:
a processor; and
a memory, configured to store a computer program executable on the processor,
wherein the processor is configured to execute the program to cause the terminal device to:
send first information, wherein the first information indicates that a first condition is met, and the first condition is determined according to at least one of:
performance of a first processing method; or
performance of at least one second processing method; and
wherein the first processing method is used for channel state information (CSI) reporting, and the second processing method is used for performance monitoring.

23. (canceled)

24. A network device, comprising:
a processor; and
a memory, configured to store a computer program executable on the processor, wherein,
the processor is configured to execute the program to cause the network device to perform the communication method according to claim 11.

25-26. (canceled)
